(19) United States
(12) Patent Application Publication
(10) Pub. No.: US 2005/0079859 A1
(43) Pub. Date: Apr. 14, 2005

(54) System and method for remotely accessing a private database

(76) Inventor: William Joseph Eakin, Mt. Laurel, NJ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/685,366

(22) Filed: Oct. 14, 2003

(51) Int. Cl. H04M 1/66; H04M 1/68; H04M 3/16

(52) U.S. Cl. 455/411; 455/410

(57) ABSTRACT

The present invention provides a system and method for remotely accessing a private database using a wireless communication device. Briefly described, one embodiment comprises receiving a private database access request from the wireless communication device, the private database access request including at least an appliance identification (ID) that uniquely identifies the wireless communication device; comparing the appliance ID with a security indicia, the security indicia associated with the wireless communication device; and communicating the information from the private database to the wireless communication device when the appliance ID corresponds to the security indicia.

### TECHNICAL FIELD

The present invention is generally related to updating programs and, more particularly, is related to a system and method for remotely accessing a private database using a wireless communication device.

### BACKGROUND

Some types of personal wireless communication devices are configured to provide access to remote databases. Access to a remote database is possible when the wireless communication device includes a display that is configured to display text and/or images. Examples of such wireless communication devices include cellular telephones and personal device assistants (PDAs).

Access to a corporate database allows businessmen and the like to remotely access inventories, thereby facilitating sales and/or inventory control. Such databases are configured to be accessed by multiple users via their wireless communication devices while in the field. Security is provided by the use of passwords or other entered identification codes, generally provided at the time the businessman accesses the database.

However, such databases are typically very large and an individual person may encounter situations where access to a large multiple-user database requires a complicated security system code. The individual may desire to limit access to that individual only. And, the individual may prefer access without the use of a complicated security system that requires the individual to provide a secret password every time the private database is accessed.

### SUMMARY

The present invention provides a system and method for remotely accessing a private database using a wireless communication device. Briefly described, one embodiment comprises receiving a private database access request from the wireless communication device, the private database access request including at least an appliance identification (ID) that uniquely identifies the wireless communication device; comparing the appliance ID with a security indicia, the security indicia associated with the wireless communication device; and communicating the information from the private database to the wireless communication device when the appliance ID corresponds to the security indicia.

Another embodiment comprises transmitting a radio frequency (RF) communication to the remote database device, the RF communication comprising a private database access request and comprising an appliance identification (ID) that uniquely identifies the wireless communication device, such that when the appliance ID corresponds to a security indicia residing in the remote database device the private database is communicated from the remote database device; and receiving a second RF communication comprising at least the private database only when the appliance ID corresponds to the security indicia.

Another embodiment comprises a transceiver configured to receive and transmit radio frequency (RF) communications; an appliance identification (ID) corresponding to a multiple-use unique identifier of the wireless communication device that is included in all transmitted RF communications from the wireless communication device; and a processor configured to cause the transceiver to transmit a first RF communication to a database device having at least one private database, the first RF communication comprising the appliance ID and a private database access request so that the database device communicates the private database via a second RF communication only when the appliance ID corresponds to a security indicia residing in the database device associated with the private database, the security indicia.

Another embodiment comprises a communication system interface configured to receive a private database access request and a multiple-use unique identifier (ID) generated by a remote wireless communication device and configured to transmit a private database to the remote wireless communication device; a security indicia that corresponds to the multiple-use unique ID, the multiple-use unique ID being included in all communications from the wireless communication device and uniquely identifying the wireless communication device; and a processor configured to compare the multiple-use unique ID to the security indicia, and further configured to cause communication of the private database to the remote wireless communication device only when the multiple-use unique ID corresponds to the security indicia.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention.

FIG. 1 is a block diagram illustrating one embodiment of a private database wireless access system in accordance with the present invention.

FIG. 2 is a block diagram illustrating additional detail of an embodiment of a private database wireless access system.

FIG. 3 is a flowchart illustrating an embodiment of a process, according to the present invention, for accessing a private database from a wireless communication device employing a private database wireless access system.

FIG. 4 is a flowchart illustrating an embodiment of a process, according to the present invention, for providing access to a private database using a private database wireless access system.

FIG. 5 is a block diagram illustrating another embodiment of a private database wireless access system in accordance with the present invention providing access via multiple wireless communication devices.

FIG. 6 is a block diagram illustrating another embodiment of a private database wireless access system.

### DETAILED DESCRIPTION

One embodiment of the present invention, a private database wireless access system, is configured to provide an individual with simplified, yet secure, access to a private database. A request for access to a private database is received by a remote database device, such as a home personal computer (PC) or the like, from the user via a wireless communication device. The private database access request includes a unique appliance identification (ID) that is uniquely associated with that wireless communication device. Accordingly, the user requesting private database access with the wireless communication device need not enter a special password or the like because the wireless communication device is recognized by the remote database device.

A private database may be a collection of private information that is generated and maintained by a single user. The information is preferably related and of a personal interest to the user. A private database as used herein is a collection information that is of personal interest to the user and generally private in nature in that the information may not be of interest to others and/or may be confidential to the user. In another embodiment, the private database may be of interest to and/or may be maintained by a group of users.

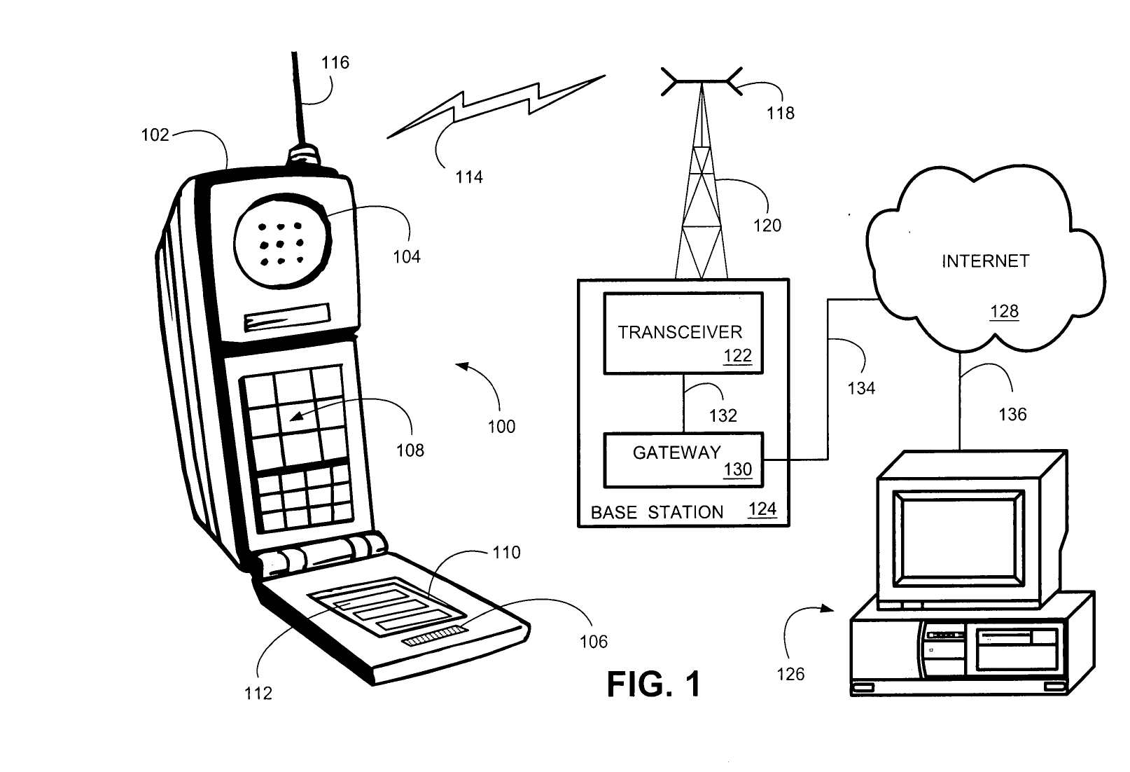

FIG. 1 is a block diagram illustrating one embodiment of a private database wireless access system in accordance with the present invention. This embodiment of the private database wireless access system 100 is illustrated for convenience as a cellular telephone (cell phone) 102. Cell phone 102 comprises a speaker 104, a microphone and a keypad 108 to facilitate voice communications. Also included is a display 110 configured to display lines of text 112, images or the like.

Cell phone 102 communicates via radio frequency (RF) signals 114, hence the reference in the arts to the cell phone 102 as a “wireless” communication device.

Voice and/or data communications are broadcasted from antenna 116, shown as an external component for convenience, as RF signals 114. RF signals 114 are detected with a base station antenna 118, typically located on a tower 120 or other high location. Received RF signals 114 are communicated to the transceiver 122 residing in the base station 124. Transceiver 122 is configured to receive and transmit RF communications.

When voice communications are received from the cell phone 102 by the transceiver 122, the voice communications are communicated via other systems such that the user of the cell phone 102 may communicate with another party at a remote location. Other types of RF signals, such as video and/or data may be supported by other systems. Accordingly, transceiver 122 is configured to receive a variety of RF signals from cell phone 102 and convert those signals to an appropriate format for further communication to other devices. Transceiver 122 is also configured to receive a variety of signals from other devices, configured to convert those signals into a suitable RF format, and configured to transmit the RF signals 114 to cell phone 102. Thus, two-way communications between the cell phone 102 and a variety of other devices is supported.

When the user of cell phone 102 accesses a private database using embodiments of the present invention, two-way communication between the cell phone 102 and a remote database device 126 is similarly supported by the transceiver 122. One embodiment accesses the private database via the Internet 128. Accordingly, a gateway 130 is coupled to the transceiver 122, via connection 132, and to the Internet 128, via connection 134. Accordingly, gateway 130 is configured to receive signals from the cell phone 102, via transceiver 122, to convert the received signals into a format suitable for communication onto the Internet 128, and to communicate the received signals onto the Internet 128. Also, gateway 130 is configured to receive, convert and communicate signals from the Internet 128 to the transceiver 122 such that cell phone 102 receives communications from the Internet 128.

Internet 128 is in communication with a remote database device 126, via connection 136. Accordingly, embodiments of the present invention are configured to enable the user of a wireless communication device, such as cell phone 102, to access a private database residing in the database device 126, via the transceiver 122, gateway 130 and the Internet 128, as described below.

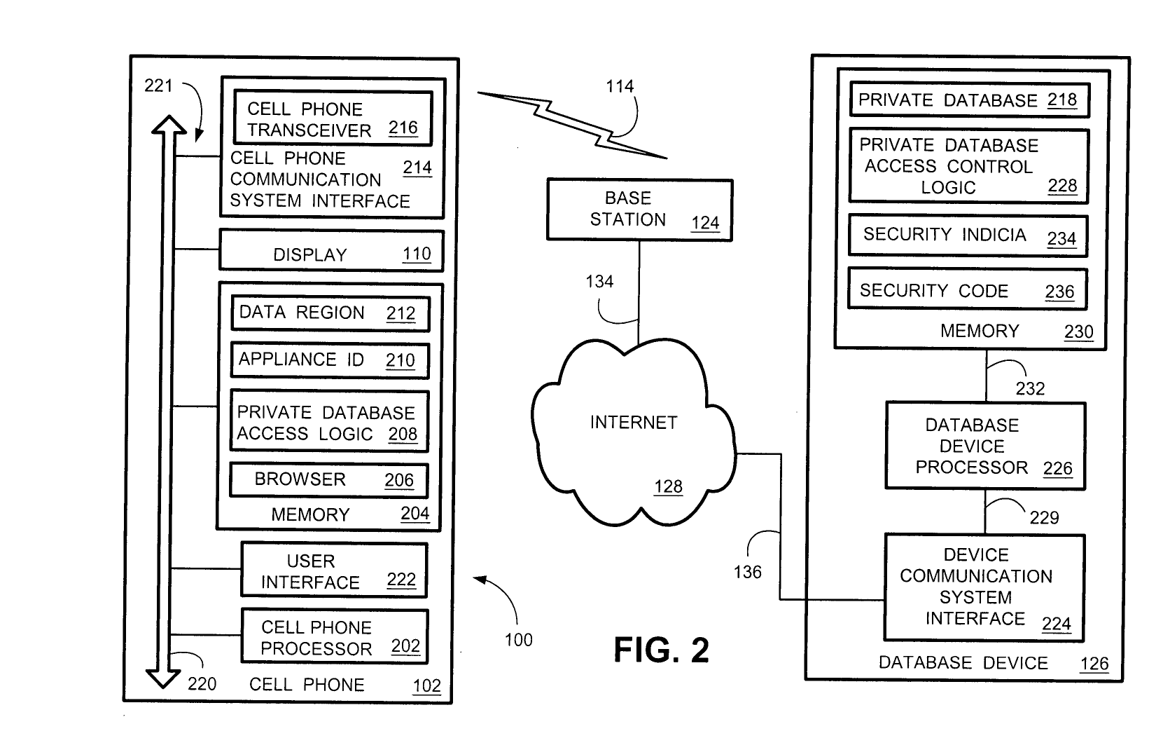

FIG. 2 is a block diagram illustrating additional detail of an embodiment of a private database wireless access system 100. For convenience, these selected components are described as residing in cell phone 102. A cell phone processor 202 controls operation of the cell phone 102. A memory 204 comprises browser 206, private database access logic 208, appliance identification (ID) 210 and data region 212.

As used herein, “remote access” refers to the use of a wireless communication medium used by the device initiating a private database access request. The wireless communication medium that enables the remote access, in one embodiment, is an RF medium. Furthermore, it is understood that the exemplary embodiment described herein for convenience is the cell phone 102. Other embodiments of the private database wireless access system 100 may be implemented in other suitable wireless devices, such as a personal device assistant (PDA), pagers or the like.

A cell phone communication system interface 214 facilitates RF communications to base station 124. When a communication is sent from the cell phone 102 to base station 124, cell phone communication system interface 214 formats the communication into a format suitable for broadcasting as RF signal 114 by the cell phone transceiver 216. Similarly, when the cell phone transceiver 216 receives a communicated RF signal 114 from base station 124, the cell phone communication system interface 214 formats the received RF signal into a format suitable for further processing by other components residing in cell phone 102. Received and transmitted communications may be voice and/or data, and when implemented with embodiments of the present invention, may be data communications associated with an accessed private database 218 residing in the database device 126.

For convenience, the components residing in cell phone 102 are illustrated as communicatively coupled to each other via communication bus 220 and connections 221, thereby providing connectivity between the above-described components. In alternative embodiments of a cell phone 102, the above-described components are connectivley coupled in a different manner than illustrated in FIG. 1. For example, one or more of the above-described components may be directly coupled to each other or may be coupled to each other via intermediary components.

Browser 206 facilitates the display of information contained in a received private database 218, which resides in the data region 212, on display 110. Instructions are provided for operation of browser 206 by the user via the user interface 222. Accordingly, user interface 222 is configured to receive information from the buttons on keypad 108 (FIG. 1) or from other actuators used to control operation of cell phone 102.

Private database access logic 208 is accessed and executed by cell phone processor 202 when the user desires to access the private database 218. Appliance ID 210 is a serial number, phone number, security code, or other suitable unique identifier, of the cell phone 102 that uniquely identifies cell phone 102. Accordingly, the appliance ID 210 is referred to herein as a multiple-use unique identifier since the appliance ID 210 uniquely identifies the appliance and identifies the appliance as an authorized device to embodiments of the private database wireless access system 100. The request to access the private database 218 is initially communicated to the database device 126. The access request identifies the private database 218, which is specified by the user via the user interface 222 and/or browser 206. Also, the private database access request comprises the appliance ID 210 so that the database device 126 may determine the source device generating the private database access request.

Database device 126 comprises at least a device communication system interface 224 that is configured to support bi-directional communications between the database device 126 and the Internet 128. Database device processor 226 analyzes the private database access request generated by cell phone 102, received from the device communication system interface 224 via connection 229. Private database access control logic 228, retrieved from memory 230 via connection 232 and executed by database device processor 226, determines if the request to access the private database 218 is generated from an RF device, such as cell phone 102, known to be used by the authorized user. That is, the private database access request having the appliance ID 210 is analyzed to determine if the appliance ID 210 corresponds to a user who is authorized to access the private database 218.

Once authorization of the cell phone 102 to access the private database 218 is verified, in accordance with the present invention, all of or a portion of the private database 218 is retrieved, communicated to cell phone 102 and stored in the data region 212 of memory 204. Accordingly, the user is able to view and browse selected portions of the received private database 218 on display 110 using the browser 206.

In one exemplary embodiment, browser 206 is configured to operate in accordance with the wireless application protocol (WAP) industry standards. Thus, browser 206 is a WAP micro-browser and communications are formatted using the WAP standard. With this embodiment, the gateway 130 (FIG. 1) is a WAP gateway configured to communicate using WAP communications over the Internet 128. Database device 126 is configured to support WAP communications. Thus, the private database is communicated as text in a suitable format, such as hyper-text markup language (HTML), wireless markup language (WML) or the like.

Other embodiments are configured to facilitate communications of the private database 218 to the wireless communication device, such as cell phone 102, using any suitable data format now known or later developed. Accordingly, browser 206 and the database device 126 are configured to communicate using the selected data format.

When embodiments of the present invention are employed to access a private database 218, the private database access request is initially communicated to the database device 126. The appliance ID 210 is compared with a predefined security indicia 234 residing in memory 230. If the received appliance ID 210 corresponds to the predefined security indicia 234, the wireless communication device requesting access to the private database 218 is recognized. Accordingly, all of, or a portion of, the private database 218 is communicated to the requesting wireless communication device.

The appliance ID 210 is communicated as a portion of the private database access request or communicated concurrently with the private database access request, depending upon the embodiment. The appliance ID 210, in one embodiment, is the assigned telephone number of cell phone 102. This cell phone 102 telephone number, or another unique identification indicia, is included in the header information or in another suitable location of the communicated RF signal 114. If implemented in another embodiment, such as a PDA, pager or other suitable RF communication device, the appliance ID 210 is preferably the number used for communication identification purposes (similar to the telephone number of cell phone 102). Other suitable unique identification indicia may be employed, such as, but not limited to, the serial number of the wireless communication device communicating the database access request. The appliance ID 210 is preferably a unique multiple-use identification indicia or identifier that is typically included in all communications from the wireless communication device.

Alternatively, the appliance ID 210 may be a special predefined identification number or indicia that uniquely identifies the wireless communication device specifically for purposes of accessing the database. The special predefined identification number or indicia would be communicated to and recognized by the database device 126.

Accordingly, when the private database access request is received by the database device 126, the user requesting private database access with the wireless communication device need not enter a special password or the like so long as the corresponding security indicia 234 resides in memory 230. For example, when the user “calls” the database device 126 with cell phone 102 to request access to the private database 218, the phone number of cell phone 102 is recognized such that the cell phone 102 is identified as a device authorized to access the private database. That is, the phone number corresponds to the appliance ID 210 in this exemplary embodiment.

In an instance where the user is using a wireless communication device for the first time to request access to the private database 218, the appliance ID 210 will not have a corresponding security indicia 234 residing in memory 230. Accordingly, upon receiving an initial access request for the first time from the wireless communication device, the private database access control logic 228 polls the user for a security code 236. Alternatively, the initial access request may be configured to have the password. Security code 236 may be a predefined password or the like known to the user. If the user responds with the correct security code 236, the received appliance ID 210 is saved as security indicia 234 and future access to the private database 218 is provided as described herein. Accordingly, when the user employs the same wireless communication device for subsequent requests for access to the private database 218, the database device 126 recognizes that wireless communication device as an authorized device. Thus, the user does not need to enter security code 236 (a password or the like) each time access to the private database 218 is requested.

In one embodiment, the user may modify the information in the private database 218, via user interface 222. The user may later communicate the modified private database 218 back to the database device 126 such that the modified private database 218 is stored into memory 230.

Private databases are predefined by the user who is authorized to have remote access to the private database 218 via a wireless communication device employing embodiments of the present invention. For example, the private database 218 may comprise a list of music owned by the user. The music database might be organized by author, song title, album title, musicians or the like. The user, while at a music store when considering a purchase, may not remember if a particular song is already owned. Using the wireless communication device, such as cell phone 102, the user may access the private database of music. Using the browser 206, the user may browse the private database 218 to determine if that particular song is already owned. There are no perceived limitations with respect to the nature, size, type or configuration of private databases. Any suitable data may comprise a private database.

In accordance with the present invention, the user may be the originator of the private database 218. Accordingly, the user's name or other suitable identifier may be associated with the private database and stored in the private database region 218. To provide private access to the private database 218, the above-described security indicia 234 may be associated with the user's name or other suitable identifier. Thus, in one alternative embodiment, the security indicia 234 corresponds to the identity of the user and the user's private database 218.

In one embodiment, the database device 126 is a personal computer or other suitable processor, such as a server, configured to provide dial-in access. Accordingly, a received private database access request causes the database device 126 to provide access to a private database 218 in accordance with the present invention. Thus, a personal computer may reside at the user's residence and be conveniently maintained by the user. Furthermore, a plurality of private databases 218 may be stored in memory 230.

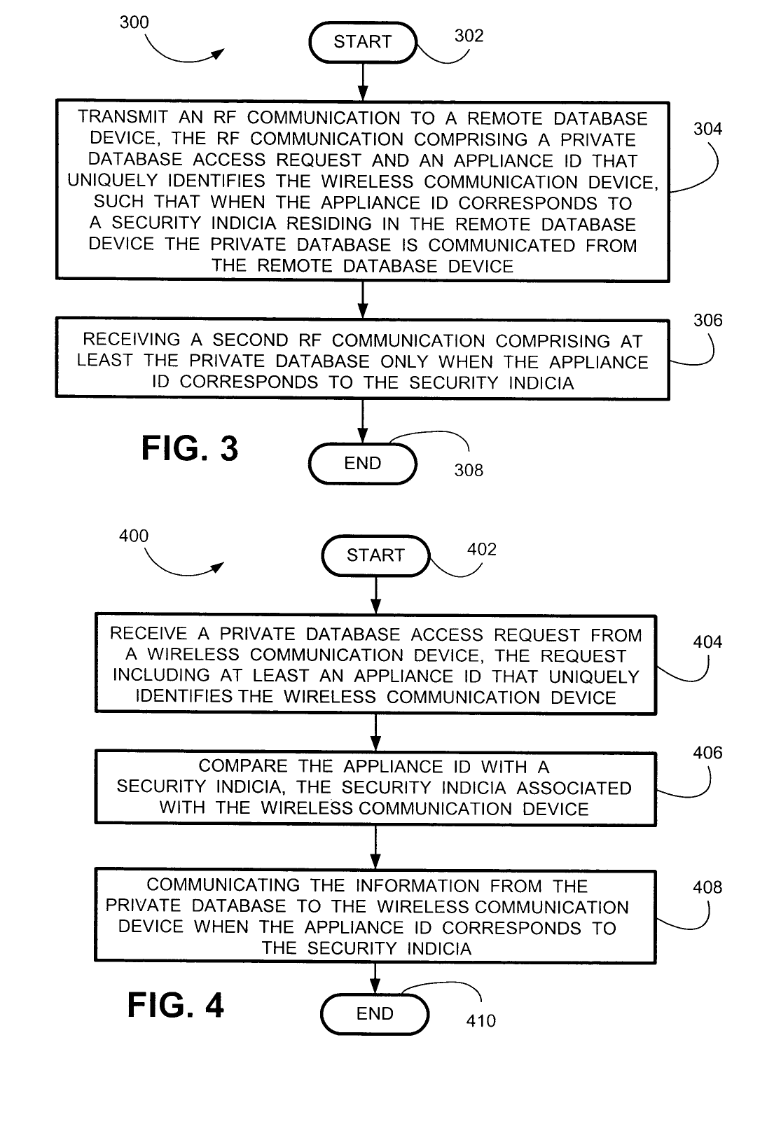

FIG. 3 is a flowchart illustrating an embodiment of a process, according to the present invention, for accessing a private database from a wireless communication device employing a private database wireless access system. Flow chart 300 illustrates the process used by an embodiment of a private database wireless access system 100 (FIG. 1). The flow chart 300 of FIG. 3 shows the architecture, functionality, and operation of an embodiment for implementing the private database access logic 208 (FIG. 2) such that the request to access the private database in a database device 126 (FIGS. 1 and 2) is generated and communicated via RF signal 114 (FIGS. 1 and 2), as described above in accordance with the present invention. An alternative embodiment implements the logic of flow chart 300 with hardware configured as a state machine. In this regard, each block may represent a module, segment or portion of code, which comprises one or more executable instructions for implementing the specified logical function(s). It should also be noted that in some alternative implementations, the functions noted in the blocks may occur out of the order noted in FIG. 3, or may include additional functions, without departing from the functionality of the private database wireless access system 100. For example, two blocks shown in succession in FIG. 3 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of the present invention.

The process begins at block 302. At block 304 a radio frequency (RF) communication is transmitted to the remote database device, the RF communication comprising a private database access request and comprising an appliance identification (ID) that uniquely identifies the wireless communication device, such that when the appliance ID corresponds to a security indicia residing in the remote database device the private database is communicated from the remote database device. At block 306 a second RF communication comprising at least the private database only when the appliance ID corresponds to the security indicia is received. The process ends at block 308.

FIG. 4 is a flowchart illustrating an embodiment of a process, according to the present invention, for providing access to a private database using a private database wireless access system. Flow chart 400 illustrates the process used by an embodiment of a private database wireless access system 100 (FIG. 1). The flow chart 400 of FIG. 4 shows the architecture, functionality, and operation of an embodiment for implementing the database access control logic 228 (FIG. 2) of a database device 126 such that a received request to access the private database in a database device 126 is processed to determine authenticity, and such that the subsequent communication of the private database is communicated to the requesting device, as described above in accordance with the present invention. An alternative embodiment implements the logic of flow chart 400 with hardware configured as a state machine. In this regard, each block may represent a module, segment or portion of code, which comprises one or more executable instructions for implementing the specified logical function(s). It should also be noted that in some alternative implementations, the functions noted in the blocks may occur out of the order noted in FIG. 4, or may include additional functions, without departing from the functionality of the private database wireless access system 100. For example, two blocks shown in succession in FIG. 4 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of the present invention.

The process begins at block 402. At block 404 a private database access request from the wireless communication device is received, the private database access request including at least an appliance identification (ID) that uniquely identifies the wireless communication device. At block 404 the appliance ID is compared with a security indicia, the security indicia associated with the wireless communication device. At block 408 the information from the private database is communicated to the wireless communication device when the appliance ID corresponds to the security indicia. The process ends at block 410.

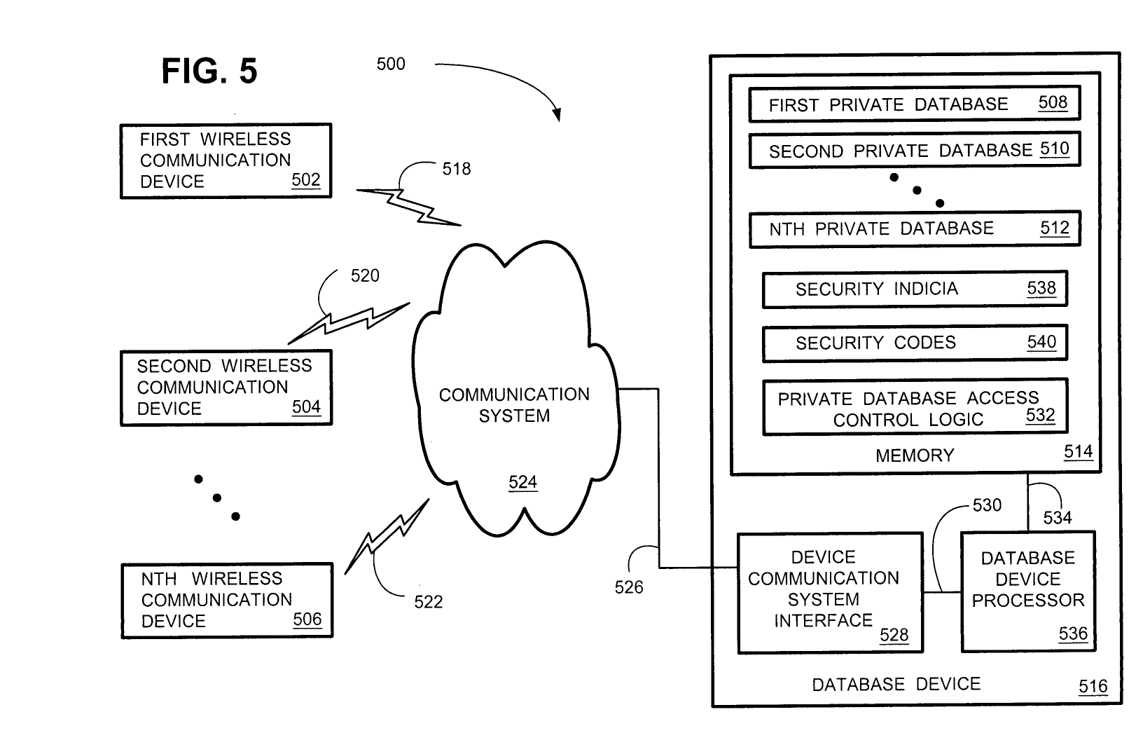

FIG. 5 is a block diagram illustrating another embodiment of a private database wireless access system in accordance with the present invention providing access via multiple wireless communication devices. The private database wireless access system 500 is configured to receive and process requests from a plurality of wireless communication devices 502, 504 and 506 to access selected private databases 508, 510 and 512 residing in memory 514 of database device 516 in accordance with the present invention disclosed herein. Wireless communication devices 502, 504 and 506 communicate private database access requests, via RF signals 518, 520 and 522, respectively, such that base stations residing in communication system 524 receive and communicate the private database requests to the database device 516, via connection 526.

Communication system 524 may be comprised of any suitable communication system, or combination of communication systems, configured to support communications between the database device 516 and the wireless communication devices 502, 504 and 506. For example, communication system 524 may be a telephony system such that the device communication system interface 528 is configured to couple to a subscriber loop or switch of a telephony communication system. Thus, one embodiment of the device communication system interface 528 comprises a suitable telephone jack for coupling to connection 526 and a suitable signal transceiver, such as a modem. Similarly, communication system 524 may be the Internet, a radio frequency (RF) wireless system, a microwave communication system, a local area network (LAN), a fiber optics system or even a satellite system. Furthermore, the communication system 524 may be a hybrid system comprised of multiple different types of communication systems now known or later developed. For example, communication system 524 may be a combination of a telephony system and the Internet.

A plurality of security indicia 538, residing in memory 514, are uniquely associated with the plurality of wireless communication devices 502, 504 and 506. Also, the private databases 508, 510 and 512 are uniquely associated with a specific user who is to have unique access to at least one of the private databases 508, 510 and/or 512.

Database device 516 comprises at least a device communication system interface 528 that is configured to support bidirectional communications between the database device 516 and the communication system 524. Database device processor 536 analyzes a received private database access request, received from the device communication system interface 528 via connection 530. Private database access control logic 532, retrieved from memory 514 via connection 534 and executed by database device processor 536, determines if the request to access the private database is generated from one of the wireless communication devices 502, 504 or 506 used by an authorized user. That is, the access request having an appliance ID is analyzed to determine if the appliance ID corresponds to a user who is authorized to access the private database residing in one of the private databases 508, 510 or 512.

For example, the first private database 508 may be associated with “user A” such that user A is the only authorized person to have access to the first private database 508. Similarly, “user B” may be associated with the second private database 510. (For example, user B might be a relative of user A residing in the same household.) User A, in possession of the first wireless communication device 502, may communicate an access request to the database device 516 in accordance with the present invention. Because the private database access request comprises an appliance ID, or is communicated concurrently with the appliance ID that uniquely identifies the first wireless communication device 502, and since the received appliance ID corresponds to one of the security indicia 538, the private database residing in the first private database 508 is communicated to the first wireless communication device 502 so that user A can browse the received private database.

Similarly, the second private database 510 may be associated with the appliance ID of the second wireless communication device 504 possessed by user B.

Accordingly, the second private database 510 is communicated to the second wireless communication device 504 when an access request is received from the second wireless communication device 504.

In some situations, a user may possess multiple wireless communication devices. For example, user A may also possess the Nth wireless communication device 506. When the Nth wireless communication device 506 communicates a database access request (which includes the appliance ID of the Nth wireless communication device 506), the first private database 508 is communicated to the Nth wireless communication device 506. Accordingly, any number of wireless communication devices may be configured to access a selected private database since the device ID associated with each of the wireless communication devices may be associated with a selected private database because each of the device ID's are associated with the security indicia of that private database.

In other situations, a single user may have multiple private databases that are accessible by at least one of their wireless communication devices. For example, user A may also be associated with the Nth private database 512. Accordingly, the access request from a wireless communication device associated with user A would include a specification for the desired private database. Thus, user A could specify that the private database residing in the Nth private database 512 is desired. Accordingly, the private database residing in the Nth private database 512 is communicated to the requesting wireless communication device, which in the exemplary examples above, may be either the first wireless communication device 502 or the Nth wireless communication device 506 (since both wireless communication devices are associated with user A and because each of the device ID's are associated with the security indicia of private databases, user A is authorized the access).

In some instances, the user may be attempting to access a private database for the first time with a wireless communication device. In accordance with the present invention, once the user initially provides a password or the like that corresponds to one of the security codes 540 associated with that user, the private database is communicated to the wireless communication device. Also, since the wireless communication device communicating the initial access request is identified as a device that is authorized to receive selected private databases, when subsequent private database access requests are communicated from that particular wireless communication device, access is provided as described above (without the need of the user having to provide the password or the like since the appliance ID of that device has been saved as one of the security indicia 538).

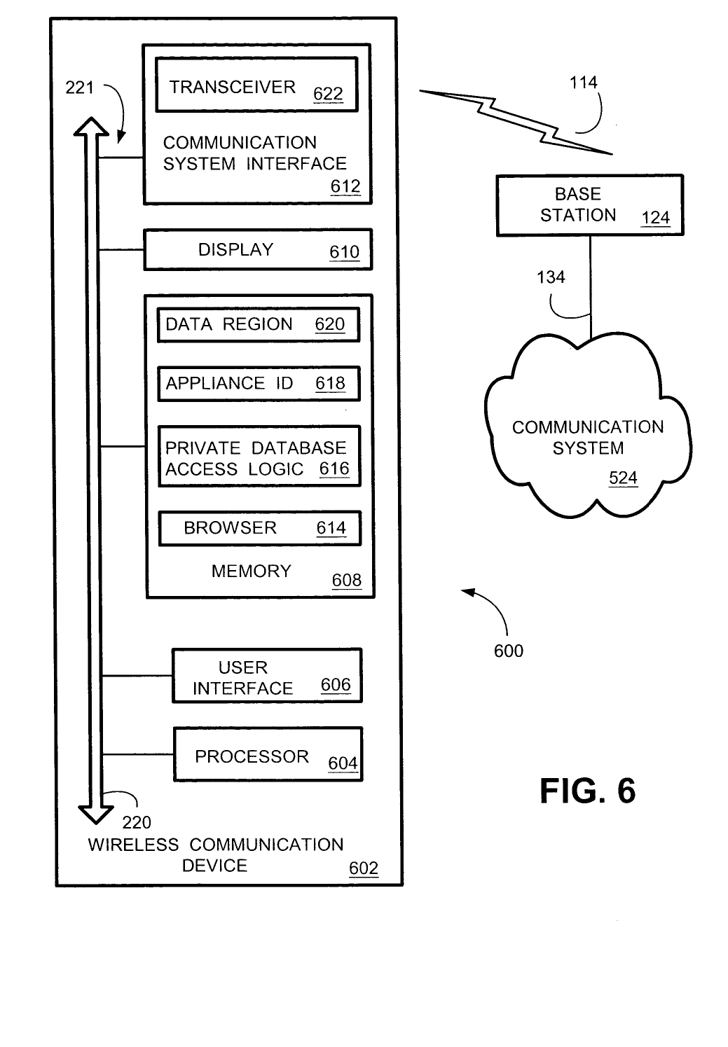

FIG. 6 is a block diagram illustrating another embodiment of a private database wireless access system. For convenience, the private database wireless access system 600 implemented in wireless communication device 602 comprises processor 604, user interface 606, memory 608, display 610 and communication system interface 612. Memory 608 comprises browser 614, private database access logic 616, appliance ID 618 and data region 620. Communication system interface 612 comprises a transceiver 622 configured to receive and transmit RF signals 114. Components of the wireless communication device 602, with respect to the present invention, operate similarly as the above-described components in cell phone 102 (FIGS. and 2). However, various embodiments of the wireless communication device 602 may perform any number of other functions, now known or later developed, in addition to providing remote access to a private database as described herein. For example, the wireless communication device 602 may be a PDA, pager or the like, that includes a calculator device or an alarm clock device. Or, the wireless communication device 602 may be limited to providing remote access to a private database as described herein.

In some embodiments, private database access control logic 228 (FIG. 2), 532 (FIG. 5) and 616 (FIG. 6) are configured to receive instructions from the authorized user such that the wireless communication device may be identified as a device that is no longer authorized to have access to a private database. An instruction from the user, received via the user interface 222 and/or browser 206 (FIG. 2), is communicated to the database device 126 (FIGS. 1 and 2) or 516 (FIG. 5). Accordingly, the security indicia associated with the wireless communication device appliance ID is deleted, erased or otherwise rendered ineffective such that a future private database access request from that particular wireless communication device is no longer accepted. For example, the above-described user A may have the temporary use of the second wireless communication device 504 (FIG. 5) (owned by user B). User A could access the first private database 508 (FIG. 5) by providing the correct password or the like that corresponds to one of the security codes 540 (FIG. 5) associated with user A. Then, at a later time, user A could instruct the database device 516 to terminate the authority of the second wireless communication device 504 to access the first private database 508. Thus, the private database 508 is not later communicated to the wireless communication device 504.

In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

1. A method for communicating information from a private database to a wireless communication device, the method comprising:
receiving a private database access request from the wireless communication device, the private database access request including at least an appliance identification (ID) that uniquely identifies the wireless communication device;
comparing the appliance ID with a security indicia, the security indicia associated with the wireless communication device; and
communicating the information from the private database to the wireless communication device when the appliance ID corresponds to the security indicia.

2. The method of claim 1, wherein the appliance ID is multiple-use identification indicia that is included in all communications from the wireless communication device.

3. The method of claim 2, wherein the multiple-use identification indicia and the security indicia correspond to a telephone number of the wireless communication device.

4. The method of claim 1, wherein the appliance ID is a unique identifier included in a header information of the private database access request from the received wireless communication device.

5. The method of claim 1, wherein communicating further comprises transmitting the information as a radio frequency (RF) signal to the wireless communication device.

6. The method of claim 1, wherein receiving the private database access request further comprises receiving information selecting one of a plurality of different private databases wherein the selected private database is communicated to the wireless communication device when the appliance ID corresponds to the security indicia.

7. The method of claim 1, further comprising;
receiving a second private database access request from a second wireless communication device, the second private database access request including at least a password generated by a user;
comparing the received password with a security code, the security code uniquely associated with the user; and
associating a second security indicia with a second unique appliance ID of the second wireless communication device when the received password corresponds to the security code, so that the private database is communicated to the second wireless communication device.

8. The method of claim 7, further comprising saving the second unique appliance ID as the second security indicia uniquely associated with the second wireless communication device.

9. The method of claim 7, further comprising:
receiving a subsequent private database access request from the second wireless communication device, the subsequent private database access request including at least the second unique appliance ID;
comparing the second unique appliance ID with the second security indicia; and
communicating the private database to the second wireless communication device when the second unique appliance ID corresponds to the second security indicia.

10. The method of claim 1, further comprising:
uniquely associating a plurality of unique appliance IDs with a plurality of unique security indicia, wherein one appliance ID uniquely identifies one of a plurality of wireless communication devices and wherein each of the security indicia are uniquely associated with one of a plurality of private databases;
receiving the private database access request from one of the plurality of wireless communication devices, the private database access request comprising at least the appliance ID of the transmitting wireless communication device and an access request to a selected private database selected from the plurality of private databases;
comparing the appliance ID of the transmitting wireless communication device with the plurality of unique security indicia; and
communicating the selected private database to the transmitting wireless communication device when the appliance ID corresponds to the security indicia of the selected private database.

11. The method of claim 1, further comprising receiving a communication from the wireless communication device that prevents association of the appliance ID with the security indicia so that communicating the private database to the wireless communication device is prevented.

12. A method for remotely accessing a private database residing in a remote database device using a wireless communication device, the method comprising:
transmitting a radio frequency (RF) communication to the remote database device, the RF communication comprising a private database access request and comprising an appliance identification (ID) that uniquely identifies the wireless communication device, such that when the appliance ID corresponds to a security indicia residing in the remote database device the private database is communicated from the remote database device; and
receiving a second RF communication comprising at least the private database only when the appliance ID corresponds to the security indicia.

13. The method of claim 12, further comprising communicating a multiple-use identification indicia corresponding to the appliance ID and that uniquely identifies the wireless communication device, and wherein the multiple-use identification indicia is included in all communications from the wireless communication device.

14. The method of claim 13, wherein the multiple-use identification indicia is a phone number.

15. The method of claim 13, further comprising:
transmitting an initial private database access request to the remote database device;
transmitting a password uniquely identifying a user of the wireless communication device; and
receiving the second RF communication comprising at least the private database only when the password corresponds to a security code residing in the remote database device, the security code associated with the user, and wherein the security code is associated with the security indicia of the private database.

16. The method of claim 15, further comprising transmitting a subsequent private database access request to the remote database device, the subsequent private database access request comprising the appliance ID, such that the second RF communication is received only when the appliance ID corresponds to the security indicia.

17. The method of claim 12, further comprising:
selecting a portion of the received private database using a browser; and
displaying the selected portion of the received private database on a display residing on the wireless communication device using the browser.

18. The method of claim 12, further comprising communicating an instruction to the remote database device that prevents association of the appliance ID with the security indicia so that communicating the private database to the wireless communication device is prevented.

19. A system that remotely accesses a private database using a wireless communication device, the wireless communication device comprising:
a transceiver configured to receive and transmit radio frequency (RF) communications;
an appliance identification (ID) corresponding to a multiple-use unique identifier of the wireless communication device that is included in all transmitted RF communications from the wireless communication device; and
a processor configured to cause the transceiver to transmit a first RF communication to a database device having at least one private database, the first RF communication comprising the appliance ID and a private database access request so that the database device communicates the private database via a second RF communication only when the appliance ID corresponds to a security indicia residing in the database device associated with the private database, the security indicia.

20. The system of claim 19, further comprising a memory configured to store the received private database.

21. The system of claim 19, further comprising:
a display; and
a browser configured to display the received private database on the display.

22. A system that provides accesses to a private database comprising:
a communication system interface configured to receive a private database access request and a multiple-use unique identifier (ID) generated by a remote wireless communication device and configured to transmit a private database to the remote wireless communication device;
a security indicia that corresponds to the multiple-use unique ID, the multiple-use unique ID being included in all communications from the wireless communication device and uniquely identifying the wireless communication device; and
a processor configured to compare the multiple-use unique ID to the security indicia, and further configured to cause communication of the private database to the remote wireless communication device only when the multiple-use unique ID corresponds to the security indicia.

23. The system of claim 22, further comprising a security code corresponding to a user associated with the private database, so that when the received ID is not initially associated with the security indicia, a password provided by the user of the remote wireless communication device causes the multiple-use unique ID to be associated with the security indicia when the password corresponds to the security code.

24. A computer-readable medium having a program for remotely accessing remote private databases using a wireless communication device, the program comprising logic configured to:
cause a transceiver to transmit a first radio frequency (RF) communication comprising a private database access request and a multiple-use unique identifier that uniquely identifies the wireless communication device, the first RF communication directed to a remote database device wherein a private database resides, and wherein the multiple-use unique identifier is included in all RF communications from the wireless communication device; and
cause the transceiver to receive a second RF communication comprising at least the private database, the private database communicated to the wireless communication device by the remote database device only when the multiple-use unique identifier corresponds to a security number residing in the remote database device.

25. A method for communicating information from a private database to a wireless telephone, the method comprising:
transmitting a radio frequency (RF) communication from the wireless telephone to a remote database device wherein the private database resides, the RF communication comprising at least a private database access request and comprising an appliance identification (ID) that uniquely identifies the wireless telephone, the appliance ID being included in all communications from the wireless telephone and uniquely identifying the wireless telephone;
receiving the private database access request and the the appliance ID by the remote database device;
comparing the appliance ID with a security indicia, the security indicia associated with the wireless communication device;
communicating the information of the private database from the remote database device when the appliance ID corresponds to the security indicia; and
receiving a second RF communication by the the wireless telephone comprising at least the information of the private database.

26. The method of claim 25 wherein the appliance ID is a telephone number.
